(19) United States
(12) Patent Application Publication
(10) Pub. No.: US 2012/0030567 A1
(43) Pub. Date: Feb. 2, 2012

(54) SYSTEM WITH CONTEXTUAL DASHBOARD AND DROPBOARD FEATURES

(76) Inventor: B. Michael Victor, Menlo Park, CA (US)

(21) Appl. No.: 12/845,694

(22) Filed: Jul. 28, 2010

(51) Int. Cl. G06F 3/048; G06F 3/01

(52) U.S. Cl. 715/702; 715/835; 715/766

(57) ABSTRACT

A user may select content that has been displayed. The selected content may be provided to multiple applications as input in response to detection of a user command such as a touch gesture. The applications may be widgets that are displayed in respective application regions surrounding a focus region. The selected text may be presented in the focus region. Each widget may produce output in its application region that is based on the selected input. A user can launch a desired widget using a swipe gesture towards the desired widget. A user may transfer the selected content using a swipe from the focus region to an application region. A user can select which widgets are included in the application regions. Displayed data items may be related to selected content. A data item may be dragged onto a widget icon to transfer the data item to an associated widget.

### BACKGROUND

This relates generally to systems for launching and using software and, more particularly, to systems that assist users in launching and using context-sensitive applications and in transferring content between applications.

Computer users often desire to share data between applications. For example, a user of an image editing program may want to email an edited image to another user. Conventionally, a user may launch the image editing program to make any desired changes to the image. After editing is complete, the user may save the image as a file in the user's file system. To email the image, the user may launch an email application and attach the image to an email message using options available in the email application.

To reduce the number of steps involved in this type of operation, a user may move data between applications using copy-and-paste operations. Copying and pasting can save time, but still requires that a user launch the appropriate destination application before performing a paste operation.

Application launching can be simplified using a customizable list of applications. The list may, for example, be provided in the form of a set of application icons that are displayed on top of a current display screen in response to a keyboard command. When a user clicks on an icon of interest, an associated program from the list may be launched. The programs that are launched in this way are sometimes referred to as widgets or gadgets. The application launch list may sometimes be referred to as a dashboard.

It is possible to add selected content to a clipboard widget by selection of an add to clipboard menu option in a web browser. Web browser content can be transferred in this way without using traditional cut and paste operations. Users can also highlight text and, upon invoking an appropriate keystroke sequence, can launch a dictionary widget to which the highlighted text has been automatically provided as an input.

The availability of shortcut techniques such as these may be helpful for users, but does not completely overcome the often cumbersome nature of conventional arrangements for launching applications and transferring content between applications.

It would therefore be desirable to provide a way in which to address the shortcomings of conventional schemes for launching applications and transferring content between applications.

### SUMMARY

Computing equipment may include a display on which content is displayed and input-output devices such as touch sensor arrays that receive user input such as touch gestures.

A user can direct the computing equipment to select a portion of the content that is being displayed on the display. For example, the user may position a cursor over a word in a page of text or may use more complex input commands to select text, images, or other content.

In response to detection of a command such as a multifinger tap command, the computing equipment may display the selected content in a focus region surrounded by a ring of application regions. Each application region may be associated with a application (e.g., a widget). The list of application regions may form a dashboard.

The widgets in the dashboard may each be provided with the selected content as input in response to detection of the command. Each widget may generate corresponding output based on the selected content. This output may be included in each of the application regions in the dashboard.

As an example, a user may select content such as a word of text and, upon making a multifinger tap command, a plurality of widgets may each process the selected word as an input to produce corresponding output. The output may be displayed in each of the regions of the dashboard. For example, a dictionary widget may display a definition for the selected word, a thesaurus may display synonyms for the selected word, etc.

The user may maximize the widget associated with a given region. For example, a user may make a swipe gesture towards the given region. Upon detection of the swipe, the computing equipment may maximize the widget (i.e., launch the widget so that the widget may display its output on the across all of most of the display).

The user may use a different type of command such as a slower swipe gesture to move the selected content from the focus region to the widget associated with given widget.

A user can select which widgets are included in the application regions. Data items in a widget may be related to selected content. A data item may be dragged onto a widget icon to transfer the data item to an associated widget.

Further features of the invention, its nature and various advantages will be more apparent from the accompanying drawings and the following detailed description of the preferred embodiments.

### BRIEF DESCRIPTION OF THE DRAWINGS

FIG. 1 is schematic diagram of an illustrative system in which applications may be launched and in which data may be transferred between applications in accordance with an embodiment of the present invention.

FIG. 2 is a schematic diagram of illustrative computing equipment that may be used in a system of the type shown in FIG. 1 in accordance with an embodiment of the present invention.

FIG. 3 is a cross-sectional side view of equipment that includes a touch sensor and display structures in accordance with an embodiment of the present invention.

FIG. 4 is a schematic diagram showing code that may be stored and executed on computing equipment such as the computing equipment of FIG. 1 in accordance with an embodiment of the present invention.

FIG. 5 is a schematic diagram showing how touch gesture data may be extracted from touch event data using touch recognition engines in accordance with an embodiment of the present invention.

FIG. 6A is a diagram of an illustrative three-finger swipe gesture in accordance with an embodiment of the present invention.

FIG. 6B is a diagram of an illustrative three-finger swipe gesture that is associated with more rapid finger movement than the gesture of FIG. 6A in accordance with an embodiment of the present invention.

FIG. 6C is a diagram of an illustrative touch input that may be used to move a cursor on a display screen in accordance with an embodiment of the present invention.

FIG. 6D is an illustrative command based on a button press and a three-finger gesture that may be used in a system in accordance with an embodiment of the present invention.

FIG. 6E is a diagram of an illustrative two-finger gesture such as a single or double two-finger tap gesture that may be used in a system in accordance with an embodiment of the present invention.

FIG. 6F is a diagram of an illustrative three-finger gesture such as a single or double three-finger tap gesture that may be used in a system in accordance with an embodiment of the present invention.

FIG. 7A shows a screen containing content and a cursor that has been positioned by a user to select a portion of the content in accordance with an embodiment of the present invention.

FIG. 7B shows a screen containing content that has been selected by a user in accordance with an embodiment of the present invention.

FIG. 8 shows a screen of applications such as widgets arranged in a ring surrounding a focus region in which selected content is presented in accordance with an embodiment of the present invention.

FIG. 9 shows a screen of the type that may be associated with an application that has been launched when a user selects one of the applications displayed in the collection of displayed applications in FIG. 8 in accordance with an embodiment of the present invention.

FIG. 10 shows a screen of the type that may be associated with a list of applications such as widgets and that contains selected content that may be supplied as input to a selected one of the widgets using a drag and drop arrangement in accordance with an embodiment of the present invention.

FIG. 11 is a flow chart of illustrative steps involved in launching applications and transferring content between applications using arrangements of the type shown in FIGS. 7A, 7B, 8, 9, and 10 in accordance with an embodiment of the present invention.

FIG. 12 is a diagram showing how selected content from an application may be presented to a user with a list of available applications and may be used as input to the available applications in accordance with an embodiment of the present invention.

FIG. 13 is a flow chart of illustrative steps involved in displaying an application launch list and selected content and in providing the selected content as input to applications in the application launch list using an arrangement of the type shown in FIG. 12 in accordance with an embodiment of the present invention.

FIG. 14 shows screens that may be presented to a user when a user selects content, when an application is launched to which the selected content is provided as an input, when selected content from the launched application is transferred to another application using a drag and drop command, and when the other application is launched by the user in accordance with an embodiment of the present invention.

FIG. 15 is a flow chart of illustrative steps involved in using a system of the type shown in FIG. 1 to perform operations of the type shown in FIG. 14 in accordance with an embodiment of the present invention.

### DETAILED DESCRIPTION

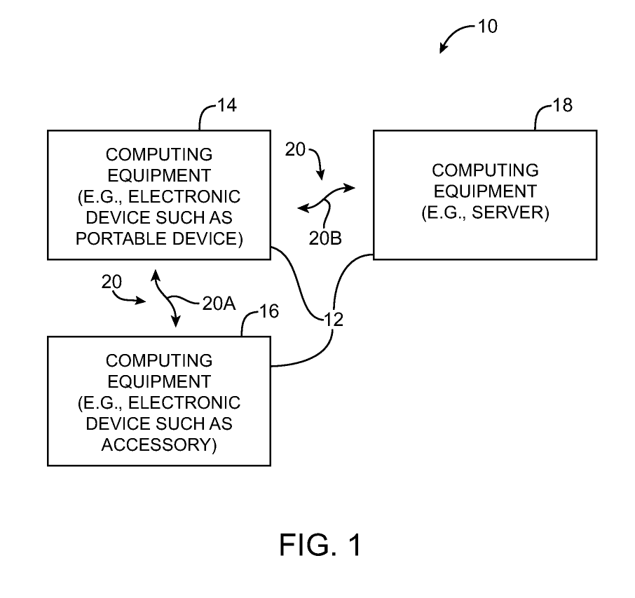

An illustrative system of the type that may be used to launch applications, to select content, and to transfer selected content between applications is shown in FIG. 1. As shown in FIG. 1, system 10 may include computing equipment 12. Computing equipment 12 may include one or more pieces of electronic equipment such as equipment 14, 16, and 18. Equipment 14, 16, and 18 may be linked using one or more communications paths 20.

Computing equipment 12 may include one or more electronic devices such as desktop computers, servers, mainframes, workstations, network attached storage units, laptop computers, tablet computers, cellular telephones, media players, other handheld and portable electronic devices, smaller devices such as wrist-watch devices, pendant devices, headphone and earpiece devices, other wearable and miniature devices, accessories such as mice, touch pads, or mice with integrated touch pads, joysticks, touch-sensitive monitors, or other electronic equipment.

Software may run on one or more pieces of computing equipment 12. In some situations, most or all of the software may run on a single platform (e.g., a tablet computer with a touch screen or a computer with a touch pad, mouse, or other user input interface). In other situations, some of the software runs locally (e.g., as a client implemented on a laptop), whereas other software runs remotely (e.g., using a server implemented on a remote computer or group of computers). When accessories such as accessory touch pads are used in system 10, some equipment 12 may be used to gather touch input or other user input, other equipment 12 may be used to run a local portion of a program, and yet other equipment 12 may be used to run a remote portion of a program. Other configurations such as configurations involving four or more different pieces of computing equipment 14 may be used if desired.

With one illustrative scenario, computing equipment 14 of system 10 may be based on an electronic device such as a computer (e.g., a desktop computer, a laptop computer or other portable computer, a handheld device such as a cellular telephone with computing capabilities, etc.). In this type of scenario, computing equipment 16 may be, for example, an optional electronic device such as a pointing device or other user input accessory (e.g., a touch pad, a touch screen monitor, a wireless mouse, a wired mouse, a trackball, etc.). Computing equipment 14 (e.g., an electronic device) and computing equipment 16 (e.g., an accessory) may communicate over communications path 20A. Path 20A may be a wired path (e.g., a Universal Serial Bus path or FireWire path) or a wireless path (e.g., a local area network path such as an IEEE 802.11 path or a Bluetooth® path). Computing equipment 14 may interact with computing equipment 18 over communications path 20B. Path 20B may include local wired paths (e.g., Ethernet paths), wired paths that pass through local area networks and wide area networks such as the internet, and wireless paths such as cellular telephone paths and wireless local area network paths (as an example). Computing equipment 18 may be a remote server or a peer device (i.e., a device similar or identical to computing equipment 14). Servers may be implemented using one or more computers and may be implemented using geographically distributed or localized resources.

In an arrangement of the type in which equipment 16 is a user input accessory such as an accessory that includes a touch sensor array, equipment 14 is a device such as a tablet computer, cellular telephone, or a desktop or laptop computer with a touch sensitive screen, and equipment 18 is a server, user input commands may be received using equipment 16 and equipment 14. For example, a user may supply a touch-based gesture to a touch pad or touch screen associated with accessory 16 or may supply a touch gesture to a touch pad or touch screen associated with equipment 14. Gesture recognition functions may be implemented on equipment 16 (e.g., using processing circuitry in equipment 16), on equipment 14 (e.g., using processing circuitry in equipment 14), and/or in equipment 18 (e.g., using processing circuitry in equipment 18). Software for handling operations associated with providing a user with lists of available applications, allowing users to select content from a running application, allowing users to launch desired applications, and allowing users to transfer content between applications may be implemented using equipment 14 and/or equipment 18 (as an example).

Subsets of equipment 12 may also be used to handle user input processing (e.g., touch data processing) and other functions. For example, equipment 18 and communications link 20B need not be used. When equipment 18 and path 20B are not used, input processing and other functions may be handled using equipment 14. User input processing may be handled exclusively by equipment 14 (e.g., using an integrated touch pad or touch screen in equipment 14) or may be handled using accessory 16 (e.g., using a touch sensitive accessory to gather touch data from a touch sensor array). If desired, additional computing equipment (e.g., storage for a database or a supplemental processor) may communicate with computing equipment 12 of FIG. 1 using communications links 20 (e.g., wired or wireless links).

Computing equipment 12 may include storage and processing circuitry. The storage of computing equipment 12 may be used to store software code such as instructions for software that handles tasks associated with monitoring and interpreting touch data and other user input. The storage of computing equipment 12 may also be used to store software code such as instructions for software that handles data and application management functions (e.g., functions associated with opening and closing files, maintaining information on the data within various files, maintaining lists of applications, launching applications, transferring data between applications, etc). Content such as text, images, and other media (e.g., audio and video with or without accompanying audio) may be stored in equipment 12 and may be presented to a user using output devices in equipment 12 (e.g., on a display and/or through speakers). The processing capabilities of system 10 may be used to gather and process user input such as touch gestures and other user input. These processing capabilities may also be used in determining how to display information for a user on a display, how to print information on a printer in system 10, etc. Other functions such as functions associated with maintaining lists of programs that can be launched by a user and functions associated with caching data that is being transferred between applications may also be supported by the storage and processing circuitry of equipment 12.

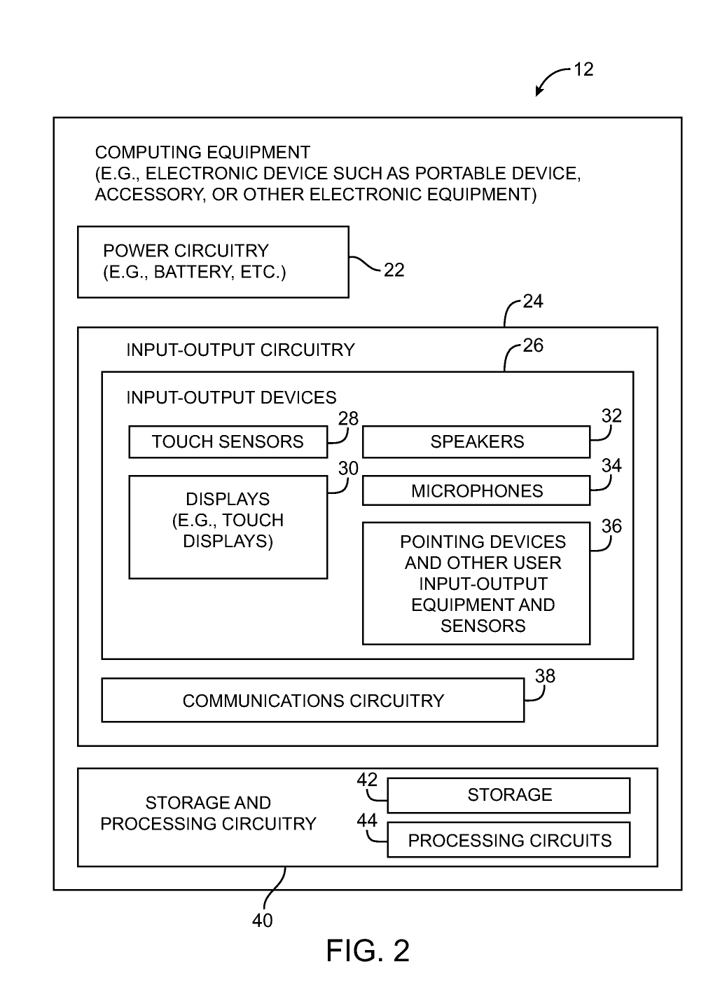

Illustrative computing equipment of the type that may be used for some or all of equipment 14, 16, and 18 of FIG. 1 is shown in FIG. 2. As shown in FIG. 2, computing equipment 12 may include power circuitry 22. Power circuitry 22 may include a battery (e.g., for battery powered devices such a cellular telephones, tablet computers, laptop computers, and other portable devices). Power circuitry 22 may also include power management circuitry that regulates the distribution of power from the battery or other power source. The power management circuit may be used to implement functions such as sleep-wake functions, voltage regulation functions, etc.

Input-output circuitry 24 may be used by equipment 12 to transmit and receive data. For example, in configurations in which the components of FIG. 2 are being used to implement equipment 14 of FIG. 1, input-output circuitry 24 may receive data from equipment 16 over path 20A and may supply data from input-output circuitry 24 to equipment 18 over path 20B.

Input-output circuitry 24 may include input-output devices 26. Devices 26 may include, for example, a display such as display 30. Display 30 may be a touch screen (touch sensor display) that incorporates an array of touch sensors. Display 30 may include image pixels formed from light-emitting diodes (LEDs), organic LEDs (OLEDs), plasma cells, electronic ink elements, liquid crystal display (LCD) components, or other suitable image pixel structures. A cover layer such as a layer of cover glass member may cover the surface of display 30. Display 30 may be mounted in the same housing as other device components or may be mounted in an external housing.

If desired, input-output circuitry 24 may include touch sensors 28. Touch sensors 28 may be included in a display (i.e., touch sensors 28 may serve as a part of touch sensitive display 30 of FIG. 2) or may be provided using a separate touch sensitive structure such as a touch pad (e.g., a planar touch pad or a touch pad surface that is integrated on a planar or curved portion of a mouse or other electronic device).

Touch sensor 28 and the touch sensor in display 30 may be implemented using arrays of touch sensors (i.e., a two-dimensional array of individual touch sensor elements combined to provide a two-dimensional touch event sensing capability). Touch sensor circuitry in input-output circuitry 24 (e.g., touch sensor arrays in touch sensors 28 and/or touch screen displays 30) may be implemented using capacitive touch sensors or touch sensors formed using other touch technologies (e.g., resistive touch sensors, acoustic touch sensors, optical touch sensors, piezoelectric touch sensors or other force sensors, or other types of touch sensors). Touch sensors that are based on capacitive touch sensors are sometimes described herein as an example. This is, however, merely illustrative. Equipment 12 may include any suitable touch sensors.

Input-output devices 26 may use touch sensors to gather touch data from a user. A user may supply touch data to equipment 12 by placing a finger or other suitable object (i.e., a stylus) in the vicinity of the touch sensors. With some touch technologies, actual contact or pressure on the outermost surface of the touch sensor device is required. In capacitive touch sensor arrangements, actual physical pressure on the touch sensor surface need not always be provided, because capacitance changes can be detected at a distance (e.g., through air). Regardless of whether or not physical contact is made between the user's finger or other eternal object and the outer surface of the touch screen, touch pad, or other touch sensitive component, user input that is detected using a touch sensor array is generally referred to as touch input, touch data, touch sensor contact data, etc.

Input-output devices 26 may include components such as speakers 32, microphones 34, switches, pointing devices, sensors, cameras, and other input-output equipment 36. Speakers 32 may produce audible output for a user. Microphones 34 may be used to receive voice commands from a user. Cameras in equipment 36 can gather visual input (e.g., for facial recognition, hand gestures, etc.). Equipment 36 may also include mice, trackballs, keyboards, keypads, buttons, and other pointing devices and data entry devices. Equipment 36 may include output devices such as status indicator light-emitting diodes, buzzers, etc. Sensors in equipment 36 may include proximity sensors, ambient light sensors, thermal sensors, accelerometers, gyroscopes, magnetic sensors, infrared sensors, etc. If desired, input-output devices 26 may include other user interface devices, data port devices, audio jacks and other audio port components, digital data port devices, etc.

Communications circuitry 38 may include wired and wireless communications circuitry that is used to support communications over communications paths such as communications paths 20 of FIG. 1. Communications circuitry 38 may, include wireless communications circuitry that forms remote and local wireless links. Communications circuitry 38 may handle any suitable wireless communications bands of interest. For example, communications circuitry 38 may handle wireless local area network bands such as the IEEE 802.11 bands at 2.4 GHz and 5 GHz, the Bluetooth band at 2.4 GHz, cellular telephone bands, 60 GHz signals, radio and television signals, satellite positioning system signals such as Global Positioning System (GPS) signals, etc.

Computing equipment 12 may include storage and processing circuitry 40. Storage and processing circuitry 40 may include storage 42. Storage 42 may include hard disk drive storage, nonvolatile memory (e.g., flash memory or other electrically-programmable-read-only memory configured to form a solid state drive), volatile memory (e.g., static or dynamic random-access-memory), etc. Processing circuitry 44 in storage and processing circuitry 40 may be used to control the operation of equipment 12. This processing circuitry may be based on one or more microprocessors, microcontrollers, digital signal processors, application specific integrated circuits, etc.

The resources associated with the components of computing equipment 12 in FIG. 2 need not be mutually exclusive. For example, storage and processing circuitry 40 may include circuitry from the other components of equipment 12. Some of the processing circuitry in storage and processing circuitry 40 may, for example, reside in touch sensor processors associated with touch sensors 28 (including portions of touch sensors that are associated with touch sensor displays such as touch displays 30). As another example, storage may be implemented both as stand-alone memory chips and as registers and other parts of processors and application specific integrated circuits. There may be, for example, memory and processing circuitry 40 that is associated with communications circuitry 38.

Storage and processing circuitry 40 may be used to run software on equipment 12 such as touch sensor processing code, productivity applications such as spreadsheet applications, word processing applications, presentation applications, and database applications, software for internet browsing applications, voice-over-internet-protocol (VOIP) telephone call applications, email applications, media playback applications, operating system functions, etc. Storage and processing circuitry 40 may also be used to run applications such as video editing applications, music creation applications (i.e., music production software that allows users to capture audio tracks, record tracks of virtual instruments, etc.), photographic image editing software, graphics animation software, etc. To support interactions with external equipment (e.g., using communications paths 20), storage and processing circuitry 40 may be used in implementing communications protocols. Communications protocols that may be implemented using storage and processing circuitry 40 include internet protocols, wireless local area network protocols (e.g., IEEE 802.11 protocols—sometimes referred to as WiFi®), protocols for other short-range wireless communications links such as the Bluetooth® protocol, cellular telephone protocols, etc.

Some of the software that is run on equipment 12 may be code of the type that is sometimes referred to as a widget or gadget application. A widget may be implemented as application software, as operating system software, as a plugin module, as local code, as remote code, other software code, or as code that involves instructions of one or more of these types. For clarity, such software code is sometimes referred to herein collectively as being an “application,” “application software,” or “a widget”.

Widgets may be smaller than full-scale productivity applications or may be as large as full-scale productivity applications. An example of a relatively small widget is a clock application. An example of a larger widget is a calendar application. In general, widgets may be any size. Small widgets are popular and, because small widgets are smaller than many applications, widgets are sometimes referred to as applets. Examples of widgets include address books, business contact manager applications, calculator applications, dictionaries, thesauruses, encyclopedias, translation applications, sports score trackers, travel applications such as flight trackers, search engines, calendar applications, media player applications, movie ticket applications, people locator applications, ski report applications, note gathering applications, stock price tickers, games, unit converters, weather applications, web clip applications, clipboard applications, clocks, etc. Applications such as these may be launched from a list of the type that is sometimes referred to as a dashboard. The list may include one or more available widgets that a user can choose to launch. List entries may be displayed in a window or other contiguous region of a computer screen, as a collection of potentially discrete overlays over an existing screen (e.g., a screen that has otherwise been darkened), in a list that is displayed along one of the edges of a computer screen (e.g., as icons), or other suitable display arrangement.

A user of computing equipment 14 may interact with computing equipment 14 using any suitable user input interface. For example, a user may supply user input commands using a pointing device such as a mouse or trackball (e.g., to move a cursor and to enter right and left button presses) and may receive output through a display, speakers, and printer (as an example). A user may also supply input using touch commands. Touch-based commands, which are sometimes referred to herein as gestures, may be made using a touch sensor array (see, e.g., touch sensors 28 and touch screens 30 in the example of FIG. 2). Touch gestures may be used as the exclusive mode of user input for equipment 12 (e.g., in a device whose only user input interface is a touch screen) or may be used in conjunction with supplemental user input devices (e.g., in a device that contains buttons or a keyboard in addition to a touch sensor array).

Touch commands (gestures) may be gathered using a single touch element (e.g., a touch sensitive button), a one-dimensional touch sensor array (e.g., a row of adjacent touch sensitive buttons), or a two-dimensional array of touch sensitive elements (e.g., a two-dimensional array of capacitive touch sensor electrodes or other touch sensor pads). Two-dimensional touch sensor arrays allow for gestures such as swipes and flicks that have particular directions in two dimensions (e.g., right, left, up, down). Touch sensors may, if desired, be provided with multitouch capabilities, so that more than one simultaneous contact with the touch sensor can be detected and processed. With multitouch capable touch sensors, additional gestures may be recognized such as multifinger swipes, multifinger taps, pinch commands, etc.

Touch sensors such as two-dimensional sensors are sometimes described herein as an example. This is, however, merely illustrative. Computing equipment 12 may use other types of touch technology to receive user input if desired.

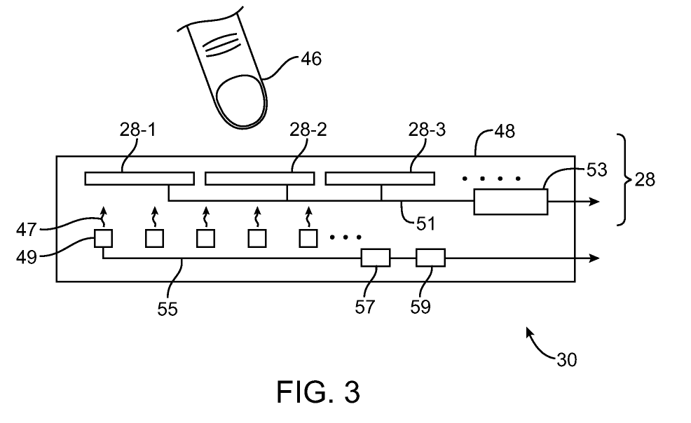

A cross-sectional side view of a touch sensor that is receiving user input is shown in FIG. 3. As shown in the example of FIG. 3, touch sensor 28 may have an array of touch sensor elements such as elements 28-1, 28-2, and 28-3 (e.g., a two-dimensional array of elements in rows and columns across the surface of a touch pad or touch screen). A user may place an external object such as finger 46 in close proximity of surface 48 of sensor 28 (e.g., within a couple of millimeters or less, within a millimeter or less, in direct contact with surface 48, etc.). When touching sensor 28 in this way, the sensor elements that are nearest to object 46 can detect the presence of object 46. For example, if sensor elements 28-1, 28-2, 28-3, . . . are capacitive sensor electrodes, a change in capacitance can be measured on the electrode or electrodes in the immediate vicinity of the location on surface 48 that has been touched by external object 46. In some situations, the pitch of the sensor elements (e.g., the capacitor electrodes) is sufficiently fine that more than one electrode registers a touch signal. When multiple signals are received, touch sensor processing circuitry (e.g., processing circuitry in storage and processing circuitry 40 of FIG. 2) can perform interpolation operations in two dimensions to determine a single point of contact between the external object and the sensor.

Touch sensor electrodes (e.g., electrodes for implementing elements 28-1, 28-2, 28-3 . . . ) may be formed from transparent conductors such as conductors made of indium tin oxide or other conductive materials. Touch sensor circuitry 53 (e.g., part of storage and processing circuitry 40 of FIG. 2) may be coupled to sensor electrodes using paths 51 and may be used in processing touch signals from the touch sensor elements. An array (e.g., a two-dimensional array) of image display pixels such as pixels 49 may be used to emit images for a user (see, e.g., individual light rays 47 in FIG. 3). Display memory 59 may be provided with image data from an application, operating system, or other code on computing equipment 12. Display drivers 57 (e.g., one or more image pixel display integrated circuits) may display the image data stored in memory 59 by driving image pixel array 49 over paths 55. Display driver circuitry 57 and display storage 59 may be considered to form part of a display (e.g., display 30) and/or part of storage and processing circuitry 40 (FIG. 2). A touch screen display (e.g., display 30 of FIG. 3) may use touch sensor array 28 to gather user touch input and may use display structures such as image pixels 49, display driver circuitry 57, and display storage 59 to display output for a user. In touch pads, display pixels may be omitted from the touch sensor and one or more buttons may be provided to gather supplemental user input.

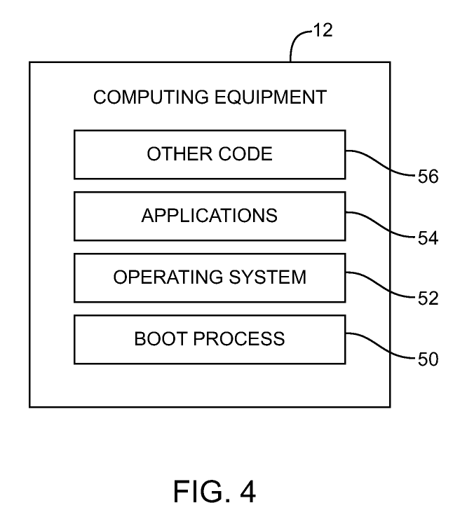

FIG. 4 is a diagram of computing equipment 12 of FIG. 1 showing code that may be implemented on computing equipment 12. The code on computing equipment 12 may include firmware, application software (e.g., widget applications), operating system instructions, code that is localized on a single piece of equipment, code that operates over a distributed group of computers or is otherwise executed on different collections of storage and processing circuits, etc. In a typical arrangement of the type shown in FIG. 4, some of the code on computing equipment 12 includes boot process code 50. Boot code 50 may be used during boot operations (e.g., when equipment 12 is booting up from a powered-down state). Operating system code 52 may be used to perform functions such as creating an interface between computing equipment 12 and peripherals, supporting interactions between components within computing equipment 12, monitoring computer performance, executing maintenance operations, providing libraries of drivers and other collections of functions that may be used by operating system components and application software during operation of computing equipment 12, supporting file browser functions, running diagnostic and security components, etc.

Applications 54 may include productivity applications such as word processing applications, email applications, presentation applications, spreadsheet applications, and database applications. Applications 54 may also include communications applications, media creation applications, media playback applications, games, web browsing application, etc. Some of these applications may run as stand-alone programs, others may be provided as part of a suite of interconnected programs. Applications 54 may also be implemented using a client-server architecture or other distributed computing architecture (e.g., a parallel processing architecture). Applications 54 may include widget applications such as address books, business contact manager applications, calculator applications, dictionaries, thesauruses, encyclopedias, translation applications, sports score trackers, travel applications such as flight trackers, search engines, calendar applications, media player applications, movie ticket applications, people locator applications, ski report applications, note gathering applications, stock price tickers, games, unit converters, weather applications, web clip applications, clipboard applications, clocks, etc. Code for programs such as these may be provided using applications or using parts of an operating system or other code of the type shown in FIG. 4, including additional code 56 (e.g., add-on processes that are called by applications 54 or operating system 52, plug-ins for a web browser or other application, etc.).

Code such as code 50, 52, 54, and 56 may be used to handle user input commands (e.g., gestures and non-gesture input) and can perform corresponding actions. For example, the code of FIG. 4 may be configured to receive touch input. In response to the touch input, the code of FIG. 4 may be configured to perform processing functions and output functions. Processing functions may include evaluating mathematical functions, moving data items within a group of items, adding and deleting data items, updating databases, presenting data items to a user on a display, printer, or other output device, sending emails or other messages containing output from a process, etc.

Raw touch input (e.g., signals such as capacitance change signals measured using a capacitive touch sensor or other such touch sensor array data) may be processed using storage and processing circuitry 40 (e.g., using a touch sensor chip that is associated with a touch pad or touch screen, using a combination of dedicated touch processing chips and general purpose processors, using local and remote processors, or using other storage and processing circuitry).

Gestures such as taps, swipes, flicks, multitouch commands, and other touch input may be recognized and converted into gesture data by processing raw touch data. As an example, a set of individual touch contact points that are detected within a given radius on a touch screen and that occur within a given time period may be recognized as a tap gesture or as a tap or hold portion of a more complex gesture. Gesture data may be represented using different (e.g., more efficient) data structures than raw touch data. For example, ten points of localized raw contact data may be converted into a single tap or hold gesture. Code 50, 52, 54, and 56 of FIG. 4 may use raw touch data, processed touch data, recognized gestures, other user input, or combinations of these types of input as input commands during operation of computing equipment 12.

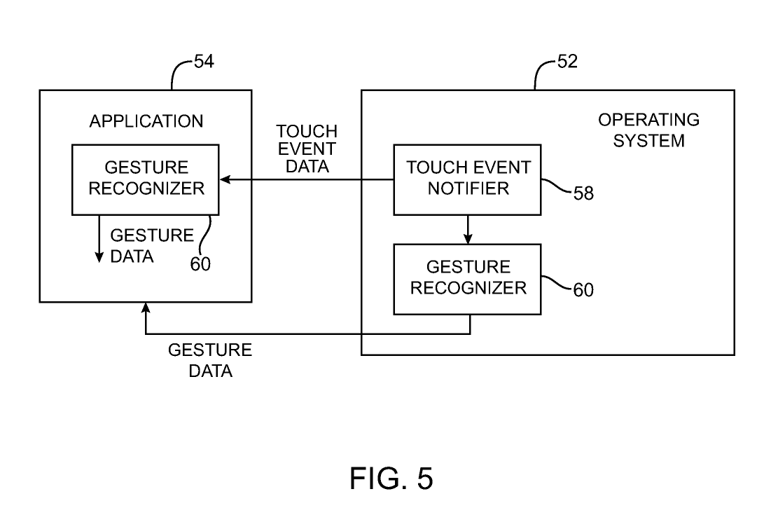

If desired, touch data (e.g., raw touch data) may be gathered using a software component such as touch event notifier 58 of FIG. 5. Touch event notifier 58 may be implemented as part of operating system 52 or as other code executed on computing equipment 12. Touch event notifier 58 may provide touch event data (e.g., information on contact locations with respect to orthogonal X and Y dimensions and optional contact time information) to gesture recognition code such as one or more gesture recognizers 60. Operating system 52 may include a gesture recognizer that processes touch event data from touch event notifier 58 and that provides corresponding gesture data as an output. An application such as application 54 or other software on computing equipment 12 may also include a gesture recognizer. As shown in FIG. 5, for example, application 54 may perform gesture recognition using gesture recognizer 60 to produce corresponding gesture data.

Gesture data that is generated by gesture recognizer 60 in application 54 or gesture recognizer 60 in operating system 52 or gesture data that is produced using other gesture recognition resources in computing equipment 12 may be used in controlling the operation of application 54, operating system 52, and other code (see, e.g., the code of FIG. 4). For example, gesture recognizer code 60 may be used in detecting gesture activity from a user to select some or all of the content that is being displayed on a display in computing equipment 12 (e.g., display 30), may be used in detecting gestures to maximize or otherwise launch applications (e.g., while providing the selected content as input), and may be used in transferring selected content between applications (e.g., without immediately launching the target application). Non-touch input may be used in conjunction with touch activity. For example, drag and drop operations may involve selecting content by positioning a cursor with touch input while holding down and then releasing a trackpad button. User button press activity may be combined with other gestures (e.g., a two-finger or three-finger swipe or a tap) to form more complex user commands.

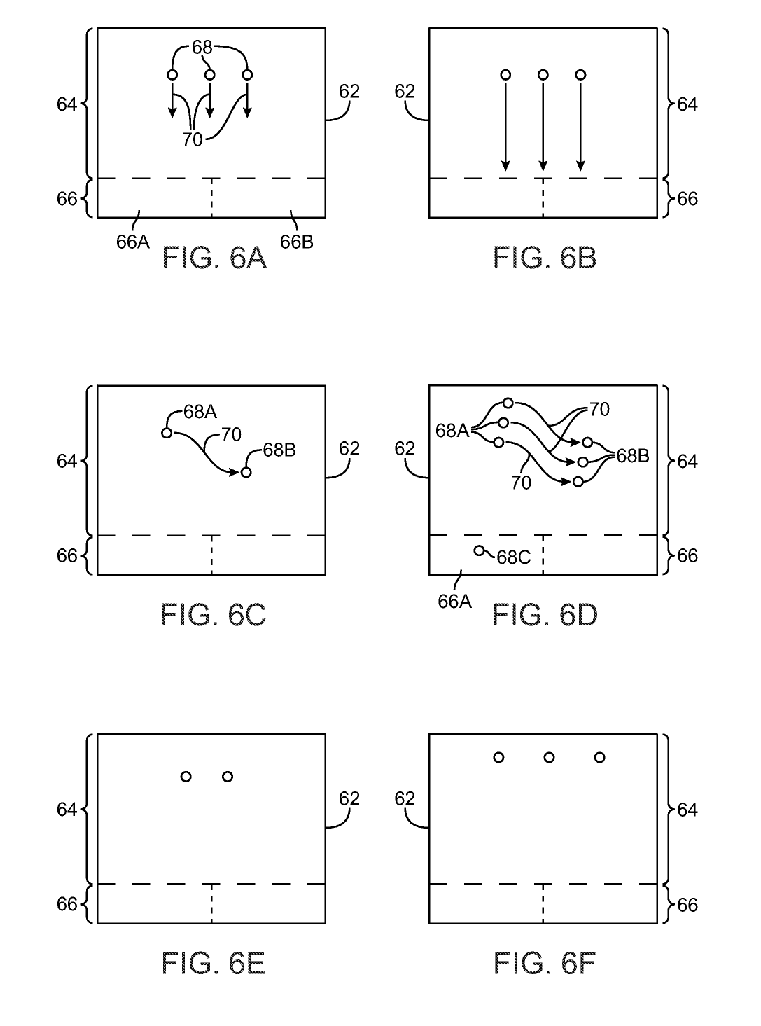

FIGS. 6A, 6B, 6C, 6D, and 6E, and 6F are diagrams of a touch pad showing illustrative user input commands of the type that may be supplied to computing equipment 12 by a user. Touch pad 62 may include a touch sensor array portion (touch sensor 64) and one or more touch pad buttons 66 such as buttons 66A and 66B. Buttons 66 may be implemented using mechanical buttons and/or as virtual buttons (e.g., using a predefined portion of a touch pad array).

As shown in FIG. 6A, a user may make a three-finger swipe gesture by contacting touch sensor array 64 at three touch points 68 using three associated fingers or other external objects and by moving touch points 68 in a swipe motion (i.e., in a downwards direction or other suitable direction as indicated by swipe paths 70 in FIG. 6A). The three-finger swipe gesture may be completed by removing the fingers (or other objects) from the touch sensor at the end of the swipe paths.

FIG. 6B shows how touch points 68 may be moved more rapidly when making a faster swipe using swipe paths 70). There are three touch points 68 in the examples of FIGS. 6A and 6B, but, in general, one, two, three, or more than three points may be associated with a swipe gesture (i.e., to form a single-finger swipe, a two-finger swipe, a three-finger swipe, etc.).

FIG. 6C shows how a user may move a cursor using a touch gesture. A user may touch point 68A with a finger and may move the finger to touch point 68B following path 70 of FIG. 6C. Simultaneously, computing equipment 12 may display and move a corresponding pointer on a display (e.g., following a path corresponding to path 70).

More than one touch point may be used in this type of arrangement (e.g., when performing a multifinger drag operation). FIG. 6D shows how multiple fingers may be moved simultaneously from points 68A to points 68B along paths 70. If desired, a user may press one or more buttons such as button 66A at the same time (e.g., at location 68C) while moving one, two, or three fingers along paths 70. A user may, for example, select content on a display by clicking on button 68C and, while holding button 68C, may drag the selected content across the screen by moving one, two, or three fingers along paths 70. The finger contact and button press may be stopped at a desired location to terminate the command.

Computing equipment 12 may process touch gestures such as taps. Taps may be made by contacting touch sensor 64 at one or more locations. A two-finger tap that involves two contact points 68 is shown in the example of FIG. 6E. A three-finger tap that involves three contact points 68 is shown in the example of FIG. 6F. More touch points may be used if desired (e.g., for four-finger touch commands) or fewer touch points may be used (e.g., for a single-finger tap). Taps may be made once (i.e., with a single up and down motion) or may be made twice in repetition (e.g., to form a double-tap gesture that includes two successive up and down motions). Triple taps may also be used in controlling equipment 12. Single taps, double taps, triple taps and taps with more repetitions may be formed using one finger (i.e., a finger or other external object), two fingers (i.e., two fingers or other external objects), three fingers (i.e., three fingers or other external objects), etc. For example, a user may control computing equipment 12 using gestures such two-finger single taps, two-finger double taps, three-finger single taps, three-finger double taps, etc.

During use of computing equipment 12, a user will generally be presented with data. For example, a user may be presented with visual and audio data in the form of text, images, audio, and video (including optional audio). Data such as this is sometimes referred to herein as content. Arrangements in which the content that is presented to a user by computing equipment 12 includes visual information that is displayed on a display such as display 30 (FIG. 2) are sometimes described herein as an example.

Content may be presented by an operating system, by an application, or other computer code. Consider, as an example, a user who is viewing web content. Typically such content may be presented by a web browser. The content that is presented by the browser may include text, images, video, etc. Other types of content that a user may be viewing include word processor content, media playback application content, spreadsheet content, image editor content, etc.

When a user is viewing content, a user may become interested in a particular portion of the content. For example, if the user is viewing images, a particular image may be of interest to the user. If the user is reading text, the user may become interested in a particular word or phrase within the displayed text.

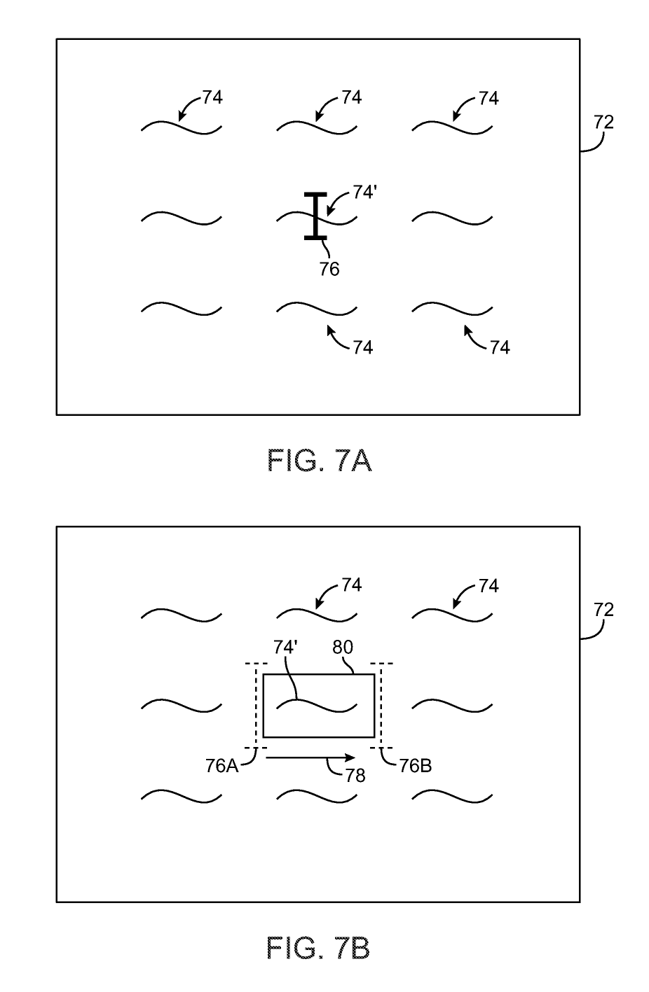

The content of interest may be selected by the user and highlighted. With one illustrative approach, a user may place a pointer over content of interest to select the content. This type of approach is shown in FIG. 7A. In the FIG. 7A example, screen 72 (which, as with the other screens shown herein, may be displayed on a display such as display 30 of FIG. 2) contains content 74. Content 74 may include text, images, video, etc. A user may use a mouse, trackball, touchpad, touch screen, or other input device to control the position of a pointer such as cursor 76 over content of interest (i.e., content 74′ in the FIG. 7A example).

FIG. 7B shows how content of interest may be selected by dragging a cursor over an area of interest on screen 72. Initially, a user may place a cursor at a location just before content of interest (i.e., at position 76A before content 74′). The user may then press a button (e.g., a button on a mouse, trackball, or touchpad) while the cursor is in position 76A. While holding the button (i.e., without releasing the button), the user may move the cursor (see, e.g., path 78) to a location just after the content of interest (i.e., position 76B after content 74′). Once position 76B has been reached, the user can release the button. This selects content 74′.

Other types of content selection schemes may be used if desired (e.g., using touch gestures, using menu commands, using taps (e.g., single, double, and triple taps), button clicks, etc. The examples of FIGS. 7A and 7B are merely illustrative.

When content is selected, computing equipment 12 may, if desired, provide visual feedback to a user. For example, the selected content may be highlighted. Content may be highlighted by changing the color of the highlighted content relative to other content, by changing the saturation of the selected content, by encircling the content using an outline (see, e.g., illustrative highlight 80 of FIG. 7B), using animated effects, by increasing or decreasing screen brightness in the vicinity of the selected content, by enlarging the size of selected content relative to other content, by placing selected content in a pop-up window or other highlight region on a screen, by using other highlighting arrangement, or using combinations of such arrangements.

Once content has been selected (and, if desired, highlighted), the content may be supplied as input to software such as an application or operating system on computing equipment 12. For example, if the user is viewing content using a given application (e.g., a web browser, word processor, image editing program, online map service, search engine, etc.), the user may transfer selected content to one or more additional applications as input (e.g., the selected content may be provided to an application such as a dictionary application, an encyclopedia application, a thesaurus, an online image management service, etc.).

Each additional application may process the selected content. For example, a thesaurus application may process selected content such as a text phrase to look up synonyms and antonyms. A search engine may perform a search for similar text (if the selected content includes text), images (if the selected content includes images), etc. An online image management service may store selected content in a local or remote database. For example, if the selected content is an image, the online image management service may store the image on a remote server (e.g., with related images).

Conventionally, a user may sometimes be able to copy and paste content between applications, but this type of cumbersome process may not always be satisfactory, particularly when a user is interested in loading selected content into multiple applications and viewing the results immediately.

Using computing equipment 12, a user can select and highlight content of interest and can transfer this content to one or more applications (or other software) using dedicated keystrokes, touch gestures, other commands, or combinations of these commands. The applications to which the selected content is provided in this way may be displayed in a list (e.g., a list of icons) along one edge of the user's display, as a list in a pop-up window, as a list of programs that are individually overlaid on top of the other information that is currently being displayed on a display, or as any other collection of applications. Each displayed application (or operation system service) in the list of applications may be identified using a program name (service name), using an icon (e.g., a graphical icon, animated icon, etc.), using a preview window or other window (e.g., using a window in which the application is running), using other suitable display formats, or using a combination of these arrangements. Lists of applications (or operating system functions) such as these are sometimes referred to herein as dashboards, because the entries in the list such as the application windows in which the applications are running sometimes have the appearance and behavior of a dashboard of gauges in a vehicle. Dashboards may serve as application launch regions, because a user may be permitted to click on a displayed dashboard item to maximize (launch) an associated application and thereby obtain access to enlarged output and/or more features.

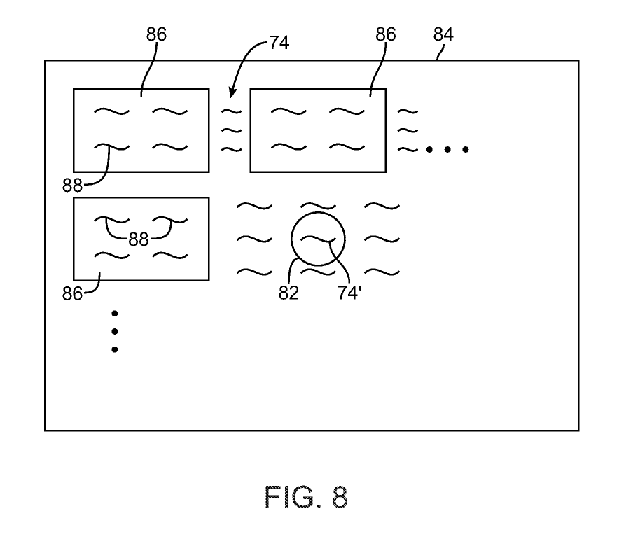

FIG. 8 shows an illustrative screen of the type that may be displayed for a user after the user has selected content of interest (e.g., selected content 74′ from content 74 of screen 72 in FIG. 7A or selected content 74′ from content 74 of screen 72 in FIG. 7B) and has directed computing equipment 12 to display an associated dashboard. Screen 84 may include some of the original content that was displayed by the application (or operating system or other software) that was displaying screen 72 of FIG. 7A or 7B. This original content may be partly obscured by the dashboard and other new content. As shown in FIG. 8, for example, original content 74 may be partly obscured by application regions 86. Application regions 86 (which may sometimes be referred to as widget regions or widgets) may include content 88. Regions 86 may be presented as an overlay on top of content 74 or other information on screen 84 or may be displayed in lists with other formats. Each region 86 may include content 88 such as an application name (e.g., a widget name), widget content (e.g., text, images, video, selectable options such as selectable text, images, and video), a widget icon, etc.

Application regions 86 may be arranged in a ring around a focus region such as focus region 82. Focus region 82 may include selected content 74′ and, if desired, nearby content for context. In the FIG. 8 example, focus region 82 is being presented in the center of screen 84. This is merely illustrative. Dashboard screens such as screen 84 may include focus regions in other locations if desired.

Each application region 86 may be associated with an application or other software. For example, one of application regions 86 may be associated with a dictionary widget, another application region 86 may be associated with a thesaurus widget, and another application region 86 may be associated with an encyclopedia widget (as examples). A user may instruct computing equipment 12 to display dashboard screen 84 using a dedicated keyboard command (including one or more keyboard keys), using one or more touch gestures (e.g., a multifinger tap gesture), by selecting an on-screen option (e.g., by clicking on a widget icon of a dashboard), or by otherwise invoking dashboard functionality. An example of a gesture that may be used to invoke screen 84 of FIG. 8 after content 74′ has been selected is a three-finger tap. Other commands may be used if desired.

In response, computing equipment 12 may provide each of the applications that are associated with application regions 86 with the content that was selected by the user to use as input. Each application that is provided with the selected content may process the selected content in accordance with the abilities of that application and may produce corresponding output (i.e., content 88) that is displayed in its corresponding region 86.

For example, if the user selected text on screen 72 (i.e., a word or phrase), computing equipment 12 may provide the selected text to each of the applications associated with the dashboard of FIG. 8 to use as an input. In response to receiving the selected text, the dictionary widget may look up a definition for the selected text, the thesaurus may look up synonyms and antonyms for the selected text, and the encyclopedia widget may look up encyclopedia entries corresponding to the selected text. Some or all of this information (e.g., the output produced by the widgets) may be displayed in associated application regions 86. For example, the dictionary widget may display the definition for the selected text as part of content 88 in one of regions 86, the thesaurus widget may display synonyms and antonyms as part of content 88 in another of regions 86, and the encyclopedia widget may display matching encyclopedia entries as content 88 in another of regions 86. In this way, multiple regions 86 may be provided with content 88 that is related to selected text 88.

The related content may be viewed immediately upon launching the dashboard and its list of application regions 86. If desired, some or all of the widgets may display a reduced amount of content (i.e., some widgets may only display unrelated content such as a clock face in a clock widget). Other widgets may display the selected content in a position indicating that further processing is possible. For example, a search widget may display selected content in a search bar, but may not conduct the search until actively requested by a user. Alternatively, search widgets (e.g., for file system search features and/or internet search engines) may perform a search using the selected content as a search term and may automatically display search results as part of content 88.

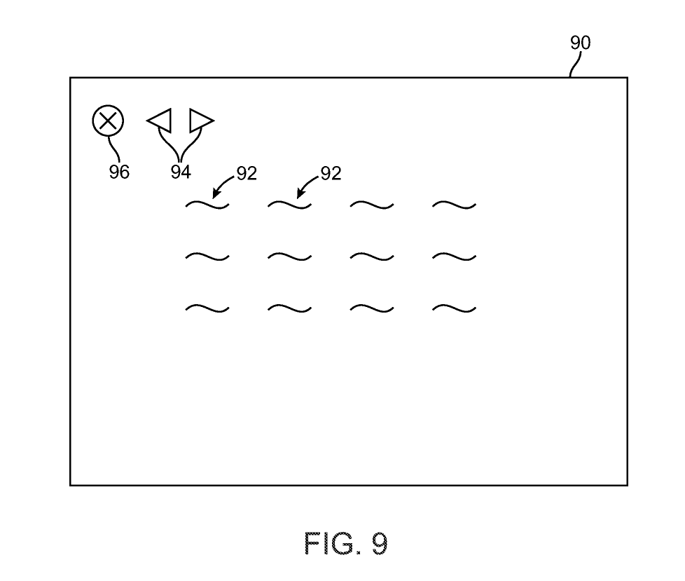

A user may select a desired one of the displayed application regions 86 of FIG. 8 (e.g., by clicking on this region using mouse or touch pad buttons, using taps and other touch sensor gestures, by swiping from region 82 towards the location of this region with a three-finger swipe or other multifinger swipe, using combinations of these arrangements, etc.). The widget (or other application or software) that is associated with the selected application region may be maximized (e.g., launched and increased in size or otherwise fully activated) in response to the user's selection. An example of a maximized widget (application) screen that may be presented when a user selects one of application regions 86 of FIG. 8 is shown in FIG. 9.

Screen 90 of FIG. 9 may be presented by running a widget (or other application or software) on computing equipment 12 and by using the running widget to process (or further process) the selected content (i.e., content 74′). Screen 90 may include corresponding related content 92. For example, if screen 90 is being presented by a dictionary widget, content 92 may include a definition corresponding to selected content 74′, if screen 90 is a thesaurus widget, content 92 may include synonyms and antonyms corresponding to selected content 74′, and if screen 90 is an encyclopedia widget, content 92 may include encyclopedia material that is related to selected content 74′. On-screen options 94 may allow a user to navigate through a history thread maintained by the widget or to perform other widget functions. Once content 92 in screen 90 has been displayed for a user, a user may select some of content 92 (e.g., using selection schemes of the type described in connection with FIGS. 7A and 7B) and can again invoke screen 84 of FIG. 8. Option 96 may be selected to return the user to the original screen on computing equipment 12 (e.g., screen 72 of FIG. 7A or 7B in the present example).

Content 92 may include some or all of content 88 of FIG. 8 and may include additional, more detailed related content. Consider, as an example, a search engine widget. In the dashboard configuration of FIG. 8, the search engine widget may use its region 86 to display a relatively short list of search results based on selected content 74′. When a user selects the search engine widget by clicking on its region 86 in the dashboard of FIG. 8, screen 90 of FIG. 9 may be launched. Because screen 90 is larger than the search engine application region in FIG. 8, the search engine may use screen 90 to display more extensive search results.

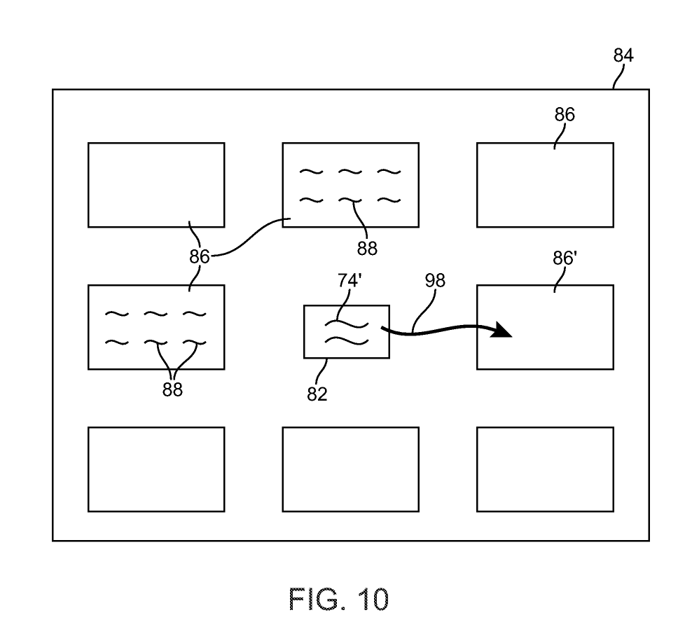

If desired, a screen such as screen 84 of FIG. 8 may be used to support “drop board” functionality that allows a user to drag and drop content such as selected content 74′ into a desired widget (or other application or software). This type of scheme is illustrated in the example of FIG. 10. As with screen 84 of FIG. 8, screen 84 of FIG. 10 may be displayed after selection of desired content (i.e., content 74′ of FIG. 7A or FIG. 7B). Screen 84 may contain one or more application regions 86. Each application region 86 may, if desired, contain content 88 (as described in connection with FIG. 8). Selected content 74′ may be presented in a focus region such as region 82. A user who desires to transfer content 74′ to a new application may drag and drop content 74′ on top of the application region associated with the desired target application. This is illustrated by drag and drop gesture 98 of FIG. 10 and target application region 86′. The software associated with target application region 86′ may be an application, an operating system function (e.g., a file browser), or other software. For example, selected content 74′ may be text and the target software may be a dictionary application, word processor application, or search engine. As another example, selected content 74′ may be an image and the target software into which the image is being drag and dropped may be an image editing application, an online image management service, or a search engine.

Drag-and-drop gesture 98 may be implemented using a pointer and a button press scheme in which the pointer is placed over content 74′, the button is pressed, and, while the button is pressed, the pointer is moved over application region 86′. Computing equipment 12 may display selected content 74′ as it is being dragged over region 86′. Once content 74′ has been positioned over region 86′, the button may be released to complete the data transfer process. If desired, a touch gesture may be used to move the selected content to the target application. For example, a user may perform a swipe gesture (e.g., a single-finger swipe, double-finger swipe, or triple-finger swipe) to move the selected content from focus region 82 to target application region 86′. Computing equipment 12 may wiggle region 86′ or may use other feedback (e.g., visual feedback) to indicate to the user that the transfer process is complete. Following the data transfer operation, screen 84 of FIG. 10 may remain visible on display 30 (e.g., so that the user may transfer the selected content to other target applications) in the list of displayed applications.

Dashboard and drop-board functions can coexist on the same screen if desired. For example, a user may perform a fast three-finger swipe from region 82 towards a desired application region when the user desires to launch the widget associated with that region as described in connection with FIGS. 8 and 9 and may perform a slow (or at least slower) three-finger swipe from region 82 towards a desired application region when the user desires to drag and drop selected content 74′ into that application region as described in connection with FIG. 10 without launching the target application. Other types of commands may be used to discriminate between these two behaviors if desired. The use of computing equipment 12 to discriminate which type of functionality is desired by monitoring the speed with which the user performs a three-finger swipe is merely illustrative. If desired, a dashboard widget may be launched by performing a swipe in the appropriate direction without waiting for the dashboard to come into view. For example, if the user has configured the dashboard so that an email application is located to the left of the focus region, the user may make a left swipe gesture after content has been selected (and, if desired, after a dashboard-invoking command has been made). Computing equipment 12 need not display the dashboard in order to process the left swipe gesture. Rather, the left swipe gesture can be used to launch the email application (populated with the selected content as input) without ever displaying the dashboard regions.

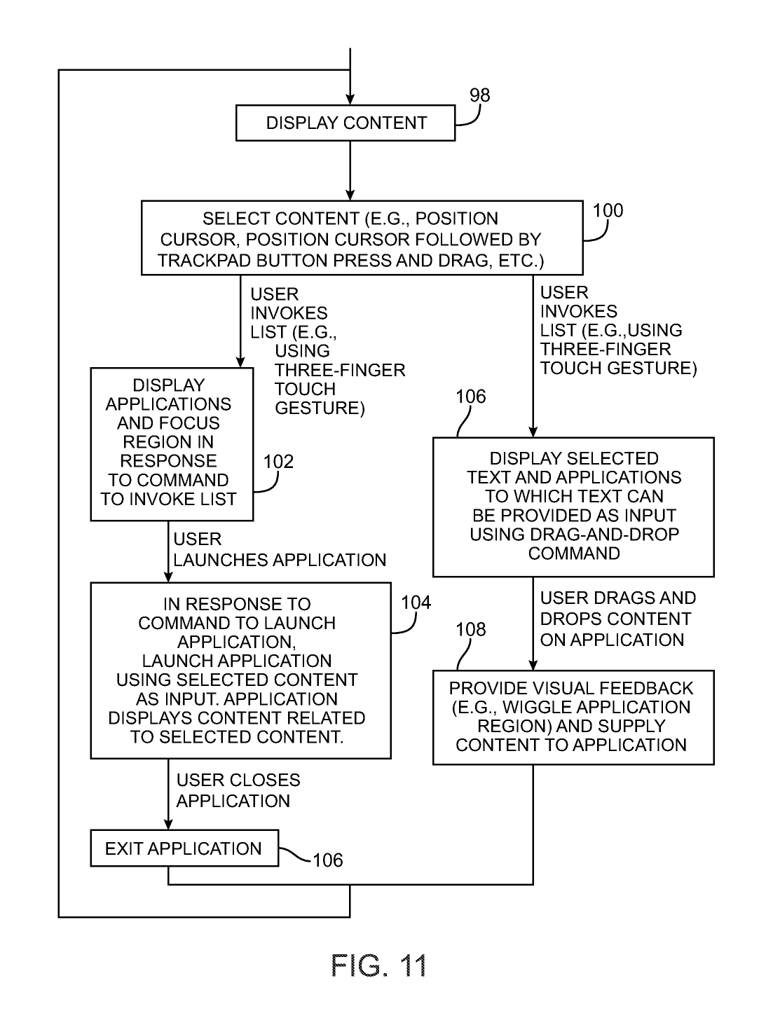

Illustrative steps involved in using computing equipment 12 to provide dashboard and drop-board functions of the type described in connection with FIGS. 7A, 7B, 8, 9, and 10 are shown in FIG. 11.

As step 98, a user may use an application, operating system function, or other software to display content 74 (see, e.g., FIGS. 7A and 7B).

A user may select content of interest (selected content 74′) during the operations of step 100 (e.g., using mouse commands, trackpad commands, touch gestures, or other schemes as described in connection with FIGS. 7A and 7B).

A user may direct computing equipment 12 to display a screen such as screen 84 of FIG. 8 by supplying an appropriate command (e.g., by clicking on a dashboard icon, by pressing a dedicated dashboard key or keys, by making a three-finger tap gesture, etc.).

In response, computing equipment 12 (using, e.g., an application or operating system component) may display screen 84 of FIG. 8 including focus region 82 (and its selected content 74′) and application regions 86 (step 102).

A desired one of the applications (or operating system functions or other software) associated with regions 86 may be run by selecting a desired region 86′ (e.g., by clicking on the region, by tapping on the region on a touch screen, by making a swipe towards the region, etc.).

In response, computing equipment 12 may, at step 104, launch the application (i.e., maximize the application), so that an application screen such as screen 90 of FIG. 9 is presented.

Regions 86 of FIG. 8 and/or screen 90 of FIG. 9 may contain content (e.g., content 88 and/or content 92) that is produced by the applications based on selected content 74′. Selected content 74′ may be provided to the applications associated with regions 86′ when screen 84 is displayed and/or when screen 90 is displayed. Each application may respond accordingly by processing this input (e.g., to produce a dictionary definition, search engine results, mapping results, stock price results, or any other type of software output that is responsive to use of the selected content as input).

A user that has been presented with a screen such as screen 90 of FIG. 9 may exit the currently running application by clicking on an exit option such as option 96 (step 106) and may thereafter return to the operations of step 98 (e.g., to view content 74 using screen 72 of FIG. 7A or screen 72 of FIG. 7B).

If desired, a user who has selected content 74′ at step 100 may direct computing equipment 12 to display a drop board screen (e.g., screen 84 of FIG. 10 of FIG. 8) by supplying a command that is different than the command used to display list 84 of FIG. 8 (e.g., a different gesture such as a three-finger double-tap, clicking on a dropboard icon, pressing dedicated key(s) different from the key(s) used to invoke dashboard functionality, etc.). In response, computing equipment 12 may display a drop-board screen, including selected content in a focus region and associated applications 86 (step 106). A user may perform drag and drop operations to move the selected content from focus region 82 to an application region (e.g., application region 86′ of FIG. 10) that is associated with a target application (step 106). In response to the drag and drop activity of the user, visual feedback may be provided (e.g., the target application region may be wiggled) and the selected content may be transferred from its original location (i.e., in the application associated with screen 72 of FIG. 7A or 7B) to the target application (step 108). Storage in computing equipment 12 may be updated accordingly.

As described in connection with FIG. 10, a single application list screen may be provided that supports both dashboard and drop board functions (i.e., the operations of steps 102 and 106 may be used to display a combined dashboard/drop-board screen). The user may launch a desired application (as with a dashboard and step 104) using one type of command (e.g., a slow three-finger swipe in the direction of a particular application and may drag and drop content (as with a drop board and step 108) using another type of command (e.g., a fast three-finger swipe onto a target application).

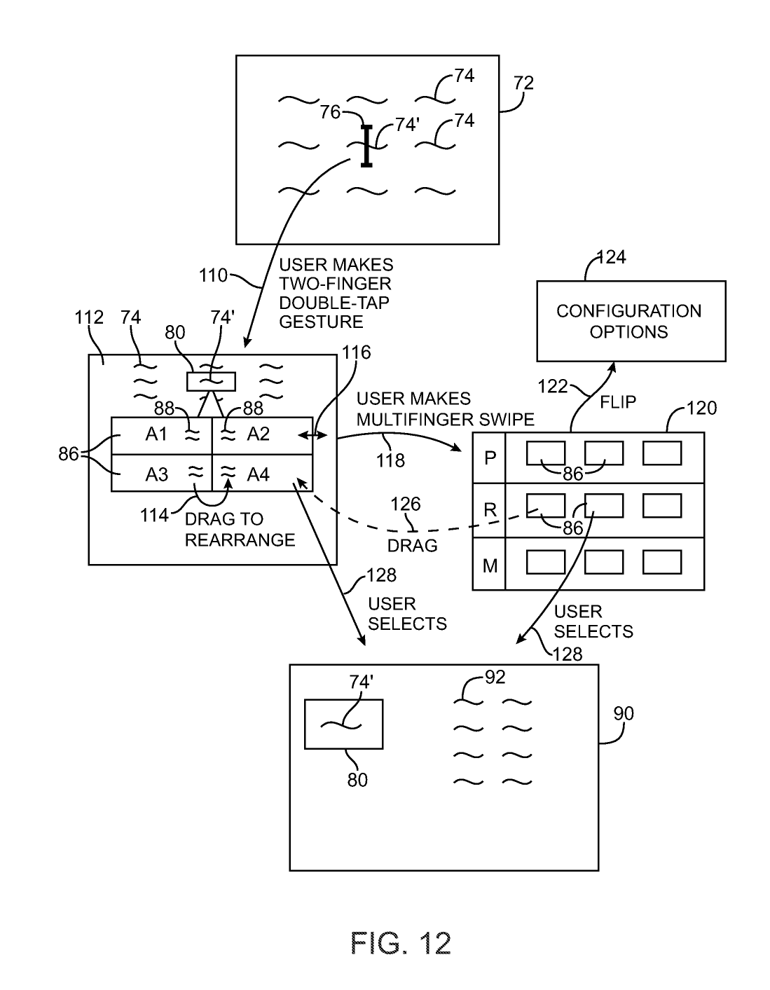

FIG. 12 shows how a user who has selected content 74′ on screen 72 (e.g., using cursor 76) may supply computing equipment 12 with a command (e.g., a two-finger double-tap gesture) that directs computing equipment 12 to display a screen such as screen 112, as indicated by line 110.

Screen 112, which may be referred to as a dashboard screen (as with screens 84 of FIGS. 8 and 10), may contain a list of application regions 86, each of which corresponds to a different application (e.g., widgets such as the widgets associated with regions 86 in FIGS. 8 and 10). Content 74 that was present in screen 72 and selected text 74′ (highlighted by highlight 80) may also be displayed in screen 112. As indicated by line 116, a user may stretch or compress the size of application regions 86 (e.g., to view more or less of optional related content 88). A user may reorganize application regions 86 by drag and drop commands (see, e.g., drag and drop command 114).

If a user uses an appropriate command (e.g., if the user makes a multifinger swipe such as a two-finger or three-finger swipe 118, computing equipment 12 may display a screen such as screen 120. Screen 120 may include numerous application regions 86. The application regions 86 of screen 120 may be, for example, widget icons. Icons 86 in the table of screen 120 may be organized in categories such as “P” (e.g., personal widgets such as widgets for managing documents, photos, and music files), “R” (e.g., reference widgets such as an encyclopedia widget, a dictionary widget, a thesaurus widget, a translator widget, etc.), and “M” (e.g., media playback and management widgets) as examples.

A user may wish to update the list of applications that appear when screen 112 is presented. For example, an author may wish to populate screen 112 with a dictionary widget, a thesaurus widget, and an encyclopedia widget, whereas a stockbroker may wish to populate the default widgets that are presented in the dashboard of screen 112 with a stock market widget, a business news widget, etc.

The user may select which widgets are used as default widgets in the application list of screen 112 using commands such as mouse commands, keyboard commands, and gestures. For example, the information of screens 112 and 120 may be displayed side by side as part of a common screen on a common display, so that a user may drag and drop an application from region 120 to the body of the application list in region 112, as indicated by line 126.

A user may adjust widget configuration options using options region 124, as indicated by path 122. The user may direct computing equipment 12 to display selectable configuration options 124 using a command such as gesture-based command) Region 120 may flip to reveal options 124, if desired.

A user may select a widget to run using a tap gesture or by clicking on one of the application regions 86 (i.e., one of the displayed widgets) in region 112 or region 120, as indicated by lines 128. In response, computing equipment 12 may display a widget screen such as screen 90. Screen 90 may contain content 92. As with content 88 of region 112, content 92 may be related to selected content 74′, which was provided to the widget as an input upon invoking the widget. Selected content 74′ and highlight 80 may also be presented in a display region such as screen 90 of FIG. 12.

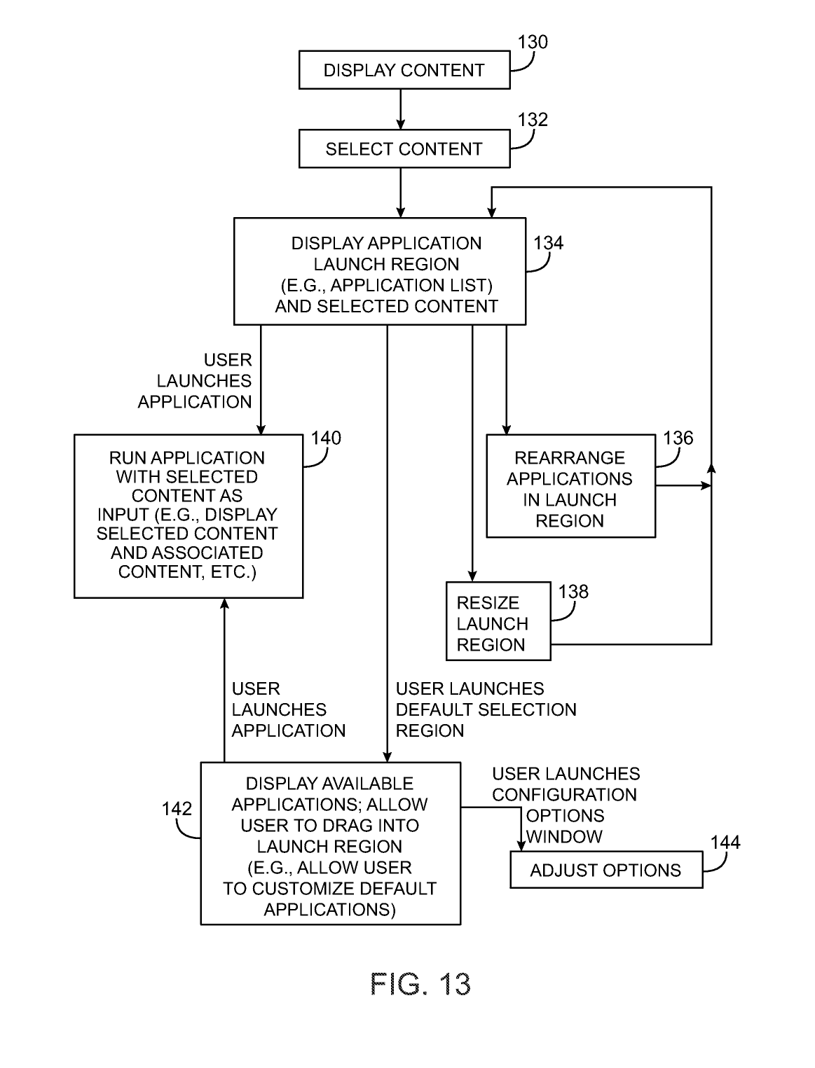

Illustrative steps involved in using computing equipment 12 to present the user with content and options of the type described in connection with FIG. 12 are shown in FIG. 13.

At step 130, content 74 may be displayed in screen 72 (e.g., by an application, by an operating system, or by other software).

The user may select content of interest (content 74′) at step 132.

In response to a user command (e.g., a two-finger double tap), computing equipment 12 may display information 112 of FIG. 12 (step 134). Region 112 may include multiple application regions 86 each of which may be associated with a different widget application (or other software). Because the regions 86 may each be associated with a different widget application, regions 86 of screen (region) 112 are sometimes referred to as a widget list or application list. The widgets in the list may be edited by the user. For example, the user may rearrange the order of the widgets in the list as described in connection with drag command 114 (step 136). The user may also modify list parameters such as the size of the list window (step 138).

Different widgets that are available for a user to include in the list of region 112 may be displayed in default application selection region 120 (step 142). A user may view and adjust configuration options 124 at step 144. A user may launch an application of interest by selecting one of application regions 86 in display screen 112 or 120 (e.g., using a tap command, using a two-finger or three-finger tap, pointing and clicking using a mouse or touch pad, etc.).

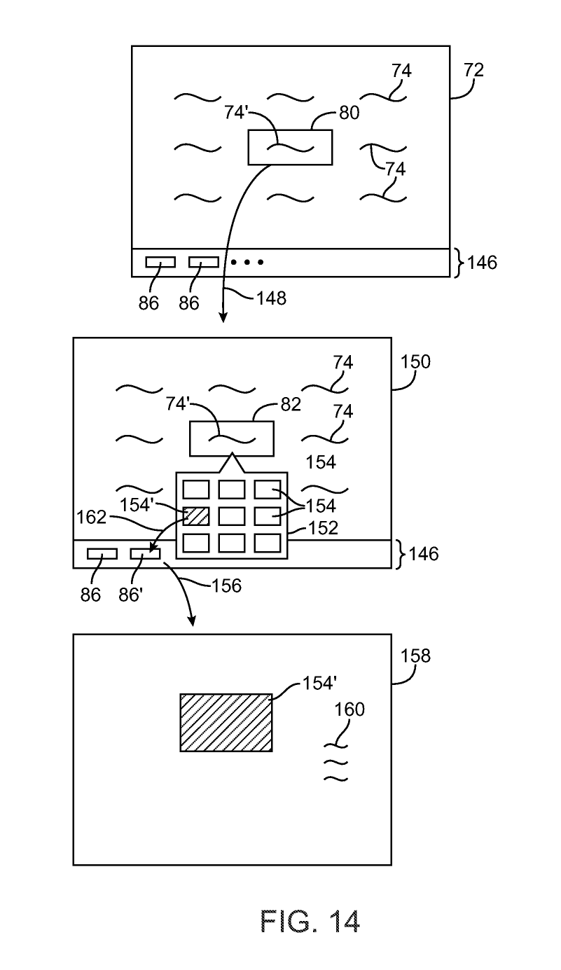

As shown in FIG. 14, an application, operating system component, or other software may display a screen such as screen 72 that includes content 74 and a region such as region 146 that contains a list of applications (e.g., widgets associated with application regions 86 such as regions containing icons). A user may select content 74′ of interest and this content may be highlighted using highlight 80. As indicated by line 148, a user who has selected and highlighted content 74′ may using a command to instruct computing equipment 12 to display an associated screen such screen 150.

Screen 150 may include some or all of the original content 74 from screen 72. Screen 150 may also include selected content 74′. Content 74′ may, for example, be presented in focus region 82. An associated region such as region 152 may be displayed as an overlay over portions of content 74 in screen 150 or using other formats.

Region 152 may include data items 154 that are related to selected content 74′. Region 152 may, for example, be displayed by and/or associated with an application or operating system function (e.g., a widget application or other software) that is related to selected content 74′.

For example, if selected content 74′ is foreign-language text, region 152 may be associated with a translator widget and data items 154 may include translated text (i.e., text that has been translated to the user's native language from original content 74′). If selected content 74′ is a person's name and if screen 72 is being presented by an address book application, region 152 may be associated with a new email message presented by an automatically launched email application (i.e., an email application automatically launched in response to selection of content 74′ and the user's command). If selected content 74′ is a number with a particular type of units (e.g., $2 or 34 meters), a conversion application can be automatically launched and items 154 can include conversion results. If item 74′ is an image, items 154 may be associated images (e.g., images maintained in an online database that is managed by an online image service). When the user selects image 74′ and enters an appropriate command, the online image service can be automatically launched by computing equipment 12 and data from the service can be presented as items 154 in region 152.

As shown by line 162, a user can transfer (e.g., copy) information between the application (widget) associated with region 152 and an application (widget) associated with one of the application regions 86 in region 146 (i.e., the application associated with region 86′) by dragging and dropping. In particular, a user may drag and drop item 154′ (e.g., an image or other content) into the application associated with region 86′ by dragging and dropping item 154′ onto region 86′ using a mouse pointer and mouse button activity, using a touch gesture, etc.

Once the drag and drop command is complete, computing equipment 12 can provide the application that is associated with region 86′ with a copy of data item 154′. In response to a user command (e.g., a click, tap, or other selection of region 86′) or automatically, computing equipment 12 may then launch the application (widget) associated with region 86′, as shown by line 156. The launched application may be, for example, an email program into which the user desired to copy data item 154′. The launched application may display a screen such as screen 158 that contains content 160 and, if desired, content 154′ (e.g., an image in the body of an email message, an image as an attachment to an email, etc.).

In general, any series of widgets (e.g., applications, operating system features, or other software) may be linked in this way. A first application may, for example, display screen 72. A second application may display overlay 152 based on the selected content from the first application. Any of the data items from the related content in region 152 may then be transferred from the second application to the third application (i.e., the application associated with icon 86′ and screen 158). The third application may be manually or automatically launched once provided with data item 154′ as input. The first, second, and third applications may be productivity applications, media editing applications, web-based applications, widgets, etc. and may be implemented as stand-alone applications, distributed software, portions of an operating system, or using any other suitable code or software components.

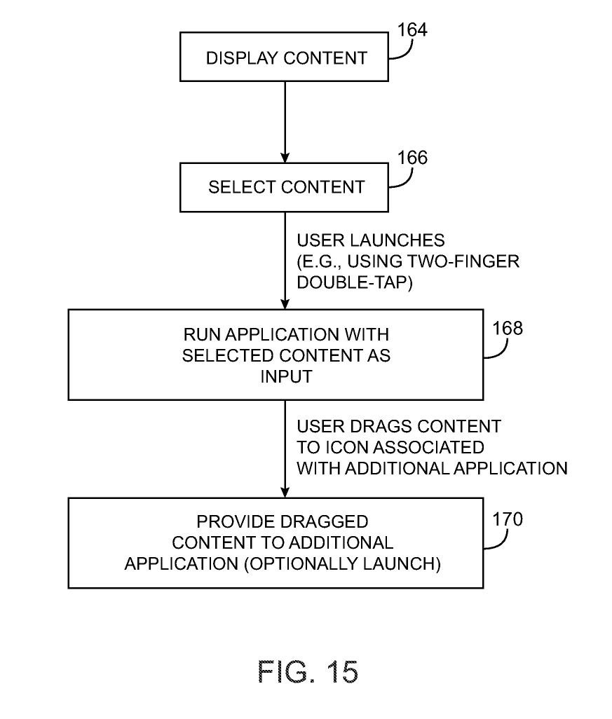

FIG. 15 shows illustrative steps involved in using computing equipment 12 (FIG. 1) to support operations of the type shown in FIG. 14.

At step 164, content 74 may be displayed for a user by a first application. The user may select content 74′ from content 74 at step 166. The user may, for example, place a cursor over particular content as described in connection with FIG. 7A or may use other selection techniques.

After selecting content 74′, the user may supply computing equipment 12 with a command such as a two-finger double tap. This command may be received and processed by computing equipment 12. In response to detecting the two-finger double tap gesture (or other suitable command), computing equipment 12 may run a second application, using the selected content as input. The second application may display data such as data items 152 (step 168). Data items 152 may include selected content 74′ and may be related to selected content 74′. For example, selected content 74′ may be text and data items 152 may be images related to the text (i.e., images in an online image management service that have keywords that match the selected text, search engine image results based on use of the selected text as search terms, etc.).

A user may use a command such as a drag and drop command to transfer data from the second application to the third application (e.g., by copying or moving). The user may, for example, drag a selected data item on top of an icon or other application region such as region 86′ that is associated with the third application (step 170). The third application may be manually or automatically launched, as described in connection with line 156 and screen 158 of FIG. 14.

The foregoing is merely illustrative of the principles of this invention and various modifications can be made by those skilled in the art without departing from the scope and spirit of the invention. The foregoing embodiments may be implemented individually or in any combination.

What is claimed is:

1. A method, comprising:
with computing equipment having a display, displaying content on the display;
with the computing equipment, allowing a user to select content from the displayed content;
receiving a user command with the computing equipment after the content has been selected; and
in response to the received command, providing the selected content as input to each of a plurality of different applications and displaying output from each of the plurality of different applications in a plurality of respective regions on the display.

2. The method defined in claim 1 wherein providing the selected content as input to each of the plurality of different applications and displaying the output from each of the plurality of different applications in the plurality of respective regions on the display comprises:
providing the selected content as input to each of a plurality of different widgets and displaying output from each of the plurality of different widgets in a dashboard that includes the plurality of respective regions on the display.

3. The method defined in claim 2 further comprising:
displaying the dashboard of widgets as separate overlays over at least part of the displayed content.

4. The method defined in claim 2 wherein receiving the user command comprises receiving a touch gesture with a touch sensor in the computing equipment.

5. The method defined in claim 2 wherein receiving the user command comprises receiving a multifinger tap gesture with a touch sensor in the computing equipment.

6. The method define in claim 2 wherein the widgets comprises a plurality of widgets selected from the group consisting of: address books, business contact manager applications, calculator applications, dictionaries, thesauruses, encyclopedias, translation applications, sports score trackers, travel applications, search engines, calendar applications, media player applications, movie ticket applications, people locator applications, ski report applications, note gathering applications, stock price tickers, games, unit converters, weather applications, web clip applications, and clipboard applications.

7. The method defined in claim 1 wherein the selected content comprises selected text and wherein providing the selected content as input to each of the plurality of different applications comprises providing the selected text as input to a plurality of applications that include at least one application selected from the group consisting of: a dictionary application, a thesaurus application, and an encyclopedia application.

8. Computing equipment, comprising:
a display on which content is displayed;
a touch sensor array; and
storage and processing circuitry that is configured to:
process user input to select content from the displayed content;
receive a touch gesture from the touch sensor array; and
display a dashboard on the display in response to the received touch gesture, wherein the dashboard includes a plurality of widget regions each of which includes content generated by a respective widget based on the selected content.

9. The computing equipment defined in claim 8 wherein the touch gesture comprises a multifinger tap gesture and wherein the storage and processing circuitry is configured to display each of the widget regions as a distinct overlay on top of the content in response to receiving the multifinger tap gesture.

10. The computing equipment defined in claim 9 wherein the storage and processing circuitry is further configured to receive a touch gesture from the touch sensor array that directs the storage and processing circuitry to maximize a selected one of the plurality of widget regions.

11. A method, comprising:
with computing equipment having a display, displaying content on the display;
with the computing equipment, allowing a user to select content from the displayed content;
receiving a user command with the computing equipment after the content has been selected;
in response to the received command, displaying output from each of the plurality of different applications in a plurality of respective regions on the display; and
in response to the received command, displaying a focus region that includes at least some of the selected content.

12. The method defined in claim 11 further comprising:
providing the selected content as input to each of a plurality of different applications in response to the received command.

13. The method defined in claim 12 wherein providing the selected content as input to each of the plurality of different applications and displaying the output from each of the plurality of different applications in the plurality of respective regions on the display comprises:
providing the selected content as input to each of a plurality of different widgets and displaying output from each of the plurality of different widgets that is based on the selected content in a dashboard that includes the plurality of respective regions.

14. The method defined in claim 13 wherein the applications comprise widgets and wherein displaying the output comprises displaying the output in the regions in a ring surrounding the focus region.

15. The method defined in claim 14 further comprising:
receiving a touch command from a user with the computing equipment; and
in response to the touch command, providing the selected content to one of the widgets.

16. The method defined in claim 15 wherein receiving the touch command comprises receiving a swipe towards one of the regions in the ring and wherein providing the selected content comprises providing the selected content to the widget associated with that region.

17. The method defined in claim 11 further comprising:
receiving a touch command; and
in response to the touch command maximizing a given one of the applications.

18. The method defined in claim 17 wherein receiving the touch command comprises receiving a first swipe towards a given one of the regions that is associated with the given one of the applications, the method further comprising:
receiving a second swipe towards the given one of the regions, wherein the second swipe is slower than the first swipe; and
in response to the second swipe, providing the selected content to the given one of the applications without launching the given one of the applications.

19. The method defined in claim 11 further comprising:
receiving a touch command; and
in response to the touch command, transferring the selected content from the focus region to a given one of the applications.

20. The method defined in claim 19 wherein receiving the touch command comprises receiving a multifinger swipe from the focus region towards a given one of the regions that is associated with the given one of the applications.

21. A method, comprising:
with computing equipment having a display, displaying content on the display;
with the computing equipment, allowing a user to select content from the displayed content;
receiving a user command with the computing equipment after the content has been selected; and
in response to the received command,
displaying a screen on the display that contains the selected content and a plurality of widgets.

22. The method defined in claim 21 further comprising:
detecting a multifinger gesture using a touch sensor in the computing equipment; and
in response to detecting the multifinger gesture, displaying a list of widgets available for inclusion in the widgets that are displayed in response to the received command; and
allowing the user to select a given one of the widgets from the displayed list of widgets to include in the widgets that are displayed in response to the received command.

23. The method defined in claim 22 further comprising:
in response to user selection of one of the plurality of widgets in the screen, displaying a screen associated with the given widget that includes the selected content.

24. The method defined in claim 22 further comprising:
presenting widget configuration options on the display associated with the list of widgets.

25. The method defined in claim 21 wherein receiving the user command comprises receiving a multifinger double tap gesture.

26. A method, comprising:
with computing equipment having a display, displaying content on the display;
with the computing equipment, allowing a user to select content from the displayed content;
receiving a user command with the computing equipment after the content has been selected; and
in response to the received command, displaying a screen on the display that contains the selected content, a plurality of widgets, and a region containing data items related to the selected content.

27. The method defined in claim 26 further comprising:
in response to user input, providing a given one of the data items to a given one of the widgets.

28. The method defined in claim 27 further comprising:
automatically launching the given widget in response to the user input.

29. The method defined in claim 27 wherein the user input comprises a drag and drop command and wherein providing one of the data items to the given one of the widgets comprises providing the given one of the data items to the given one of the widgets in response to the drag and drop command.
